(19) United States
(12) Patent Application Publication
(10) Pub. No.: US 2017/0171835 A1
(43) Pub. Date: Jun. 15, 2017

(54) A Network Node, a User Equipment, and Methods Therein

(71) Applicant: Telefonaktiebolaget LM Ericsson (publ), Stockholm (SE)

(72) Inventors: Peter Ökvist, Luleå (SE); Jonas Fröberg Olsson, Ljungsbro (SE); Fredrik Gunnarsson, Linköping (SE); Tomas Jönsson, Luleå (SE)

(21) Appl. No.: 15/030,798

(22) PCT Filed: Oct. 14, 2015
(86) PCT No.: PCT/SE2015/051087

§ 371 Date: Apr. 20, 2016

Related U.S. Application Data
(60) Provisional application No. 62/202,933, filed on Aug. 10, 2015.

(51) Int. Cl. H04W 64/00; H04W 8/08

(52) U.S. Cl. CPC H04W 64/006; H04W 8/08; H04W 88/08

(57) ABSTRACT

A method performed by a network node is provided. The network node and a user equipment, UE, operate in a communications network.

The network node configures (302) the UE to report information indicating whether the UE is located indoors or outdoors.

After receiving (303) a message from the UE which message comprises the information indicating whether the UE is located indoors or outdoors, the network node decides (304) whether the UE is located indoors or outdoors based on the received indication. The deciding enables the network node to provide network support in the communications network based on whether the UE is located indoors or outdoors.

### TECHNICAL FIELD

Embodiments herein relate to a network node, a user equipment and methods therein. In particular they may relate to deciding whether the UE is located indoors or outdoors.

### BACKGROUND

Wireless devices or terminals for communication are also known as e.g. User Equipments (UE), mobile terminals, wireless terminals and/or mobile stations. Wireless devices are enabled to communicate wirelessly in a cellular communications network or wireless communication system, sometimes also referred to as a cellular radio system or cellular networks. The communication may be performed e.g. between two wireless devices, between a wireless device and a regular telephone and/or between a wireless device and a server, such as server providing video streaming service, via a Radio Access Network (RAN) and possibly one or more core networks, comprised within the cellular communications network.

Wireless devices may further be referred to as mobile telephones, cellular telephones, computers, or surf plates with wireless capability, just to mention some further examples. The wireless devices in the present context may be, for example, portable, pocket-storable, hand-held, computer-comprised, or vehicle-mounted mobile devices, enabled to communicate voice and/or data, via the RAN, with another entity, such as another wireless device or a server.

A cellular communications network covers a geographical area which is divided into cell areas, wherein each cell area is served by a base station, e.g. a Radio Base Station (RBS), which sometimes may be referred to as e.g. eNodeB (eNB), NodeB, B node, Base Transceiver Station (BTS), or AP (Access Point), depending on the technology and terminology used. The base stations may be of different classes such as e.g. macro eNodeB, home eNodeB or pico base station, based on transmission power and thereby also cell size. A cell is the geographical area where radio coverage is provided by the base station at a base station site. One base station, situated on the base station site, may serve one or several cells. Further, each base station may support one or several communication technologies. The base stations communicate over the air interface operating on radio frequencies with the wireless devices within range of the base stations. The base stations and wireless devices involved in communication may also be referred to as transmitter-receiver pairs, where the respective transmitter and receiver in a pair may refer to a base station or a wireless device, depending on the direction of the communication. Two wireless devices involved in D2D communication may also be referred to as a transmitter-receiver pair. In the context of this disclosure, the expression Downlink (DL) is used for the transmission path from the base station to a wireless device. The expression Uplink (UL) is used for the transmission path in the opposite direction i.e. from the wireless device to the base station.

Universal Mobile Telecommunications System (UMTS) is a third generation mobile communication system, which evolved from the GSM, and is intended to provide improved mobile communication services based on Wideband Code Division Multiple Access (WCDMA) technology. UMTS Terrestrial Radio Access Network (UTRAN) is essentially a radio access network using wideband code division multiple access for communication with terminals. The 3GPP has undertaken to evolve further the UTRAN and GSM based radio access network technologies.

In 3rd Generation Partnership Project (3GPP) Long Term Evolution (LTE), base stations, which may be referred to as eNodeBs or even eNBs, may be directly connected to one or more core networks.

3GPP LTE radio access standard has been written in order to support high bitrates and low latency both for uplink and downlink traffic. All data transmission is in LTE is controlled by the radio base station.

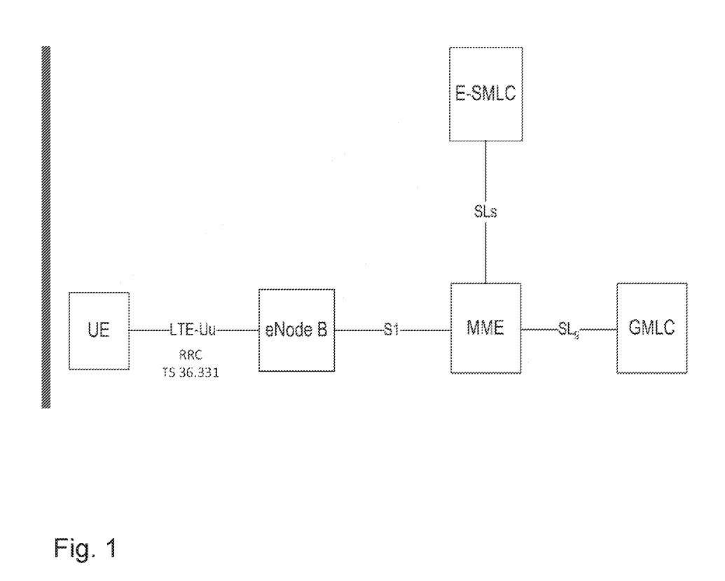

Positioning of terminals can take advantage of network support in communication networks, and communication links in a communication network may be used to share positioning information. In 3GPP LTE is supported by the network architecture illustrated by FIG. 1. LTE-Uu is the interface between a UE and an eNodeB and is specified among others in the RRC protocol in 3GPP LTE Technical Specification (TS) 36.331, S1-MME is the interface between an eNodeB and an Mobility Management Entity (MME). SLg is the interface between an MME and a Gateway Mobile Location Centre (GMLC) which is specified in 3GPP LTE TS 29, 172. SLₛ is the interface between an E-SLMC and an MME which is specified in 3GPP LTE TS 29, 171. Direct interactions between a UE and a location server Evolved-Serving Mobile Location Centre (E-SMLC) are via the LTE Positioning Protocol (LPP) such as specified in TS 36.355. Examples of such interactions include:
requesting positioning capabilities from the UE
providing the UE with assistance data, for example to support the UE in detecting satellites for Global Navigation Satellite System (GNSS) positioning, detecting positioning reference signals from base stations, etc.
receiving from the UE, location information including measurements or position estimates
etc.

Furthermore, there are also extensions to LPP discussed outside 3GPP in Open Mobile Alliance (OMA) that can be conveyed in a dedicated LPP container. The extension protocol is denoted LPPe in the OMA LPP Extensions Specification.

Moreover, there are also interactions between the location server and the eNodeB via the LPPa protocol specified in 3GPP LTE TS 36.455, to share both common and UE specific information between an eNodeB and E-SMLC. LPPa is the LPP, part between eNodeB and E-SMLC. To some extent, the information shared via LPPa can be requested by the eNodeB from the UE via the Radio Resource Control (RRC) protocol.

The following positioning techniques are considered in LTE (3GPP 36.305):
Enhanced Cell ID. Essentially cell ID information to associate the UE to the serving area of a serving cell, and then additional information to determine a finer granularity position.
Assisted Global Navigation Satellite System GNSS. GNSS information retrieved by the UE, supported by assistance information provided to the UE from E-SMLC
OTDOA (Observed Time Difference of Arrival). The UE estimates the time difference of reference signals from different base stations and sends to the E-SMLC for multi-alteration.
UTDOA (Uplink TDOA). The UE is requested to transmit a specific waveform that is detected by multiple location measurement units (e.g. an eNB) at known positions. These measurements are forwarded to E-SMLC for multi-alteration

However even if the positioning of UEs is a valuable information for the network performance, this information may be ambiguous or uncertain.

### SUMMARY

It is therefore an object of embodiments herein to improve the performance in a communications network.

### EXEMPLARY EMBODIMENTS

According to a first aspect of embodiments herein, the object is achieved by a method performed by a network node. The network node and a user equipment, UE, operate in a communications network.

The network node configures the UE to report information indicating whether the UE is located indoors or outdoors.

After receiving a message from the UE which message comprises the information indicating whether the UE is located indoors or outdoors, the network node decides whether the UE is located indoors or outdoors based on the received indication. The deciding enables the network node to provide network support in the communications network based on whether the UE is located indoors or outdoors.

According to a second aspect of embodiments herein, the object is achieved by a method performed by a User Equipment, UE. The UE and a network node operate in a communications network. The UE is configured by the network node to report information indicating whether the UE is located indoors or outdoors, After establishing an indication whether the UE is located indoors or outdoors, the UE sends a message to the network node which message comprises information about the established indication whether the UE is located indoors outdoors.

According to a third aspect of embodiments herein, the object is achieved by a method performed by a network node. The network node and a user equipment. UE, are arranged to operate in a communications network. The network node is configured to:
configure the UE to report information indicating whether the UE is located indoors or outdoors,
receive a message from the UE which message comprises the information indicating whether the UE is located indoors or outdoors,
decide whether the UE is located indoors or outdoors based on the received indication, which deciding enables the network node to provide network support in the communications network based on whether the UE is located indoors or outdoors.

According to a fourth aspect of embodiments herein, the object is achieved by a User Equipment, UE, which UE and a network node are arranged to operate in a communications network, the UE is configured to:
be configured by the network node to report information indicating whether the UE is located indoors or outdoors,
establish an indication whether the UE is located indoors or outdoors,
send a message to the network node which message comprises information about the established indication whether the UE is located indoors outdoors.

Embodiments herein provide a way of signalling indoor/outdoor information from the UE to the network node which enables the network node to provide network support in the communications network based on a decision whether the UE is located indoors or outdoors.

### DETAILED DESCRIPTION

As part of developing embodiments herein, a problem will first be identified and shortly discussed.

In cellular networks of today, it is an increasing interest to determine if a UE/user is located indoors or outdoors. This is interesting from many aspects, for example radio network algorithms, network tuning, and positioning. For example, in a specific situation where it is desired to locate a user equipment, and the location is ambiguous or uncertain, it may be of significant use to know if the user is actually indoors or outdoors. It may even help determine true location the location of the user.

Currently there is not any existing technology for indoor/outdoor classification, but there are a number of proposed methods in a UE to detect that the UE is indoors.

Pengfei Zhou, Yuanqing Zheng, Zhenjiang Li, Mo Li, and Guobin Shen, “IODetector: A Generic Service for Indoor Outdoor Detection”, SenSys'12, Nov. 6-9, 2012, Toronto, ON, Canada, describes examples of such indoor/outdoor classification.

However, there is currently no arranged way of signalling indoor/outdoor information from the UE to the communications network. There is further no signalling that enables the network to assist the UE in indoor/outdoor classification.

Embodiments herein are based on a capability of a UE to establishing an indication whether the UE is located indoors or outdoors by e.g. classify whether it is indoors or outdoors, or make a measurement of a quantity that is different indoors or outdoors.

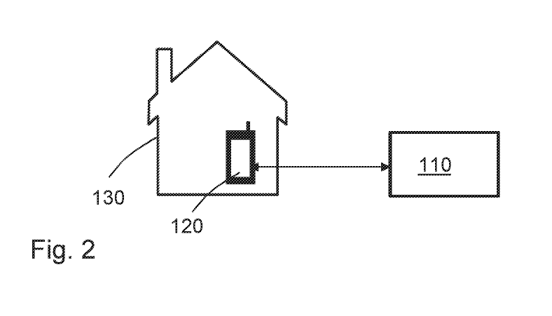

FIG. 2 depicts an example of a communications network 100 in which embodiments herein may be implemented. The communications network 100 may be a wireless communication network such as an LTE, WCDMA, GSM network, any 3GPP cellular network such as furture Nx and 5G cellular networks, or any cellular network or system. The architecture of the communications network 100 may be of the kind as depicted in FIG. 1 above.

A plurality of network nodes operates in the communications network 100 whereof one, a network node 110 is depicted in FIG. 2. The network node 110 may for example be a base station such as an eNodeB, a NodeB, a Home Node B, a Home eNode B, or any other network node capable to serve a UE in a wireless communications network. The network node 110 may further be an E-SMLC, a MME or a Gateway Mobile Location Centre (GMLC). The network node 110 may also be represented by a distributed network node by means of cloud computing enabling ubiquitous network access to a shared pool of configurable computing resources.

A UE 120 operates in the wireless communications network 100. The UE 120 is served by the network node 110.

The UE 120 may e.g. be a wireless device, a mobile wireless terminal or a wireless terminal, a mobile phone, a computer such as e.g. a laptop, a Personal Digital Assistants (PDAs) or a tablet computer, sometimes referred to as a surf plate, with wireless capability, or any other radio network units capable to communicate over a radio link in a wireless communications network, Please note that the term UE used in this document also covers other wireless devices such as Machine to machine (M2M) devices.

The UE 120 may be indoors e.g. in a building 130, as in the scenario depicted in FIG. 2. The UE 120 may further be outdoors (not shown). Herein, indoors is defined as inside a building such as in the building 130 and outdoor is defined as everything else that is not inside a building. Building such as the building 130 here means any type of building such as e.g. a house, a mall, an airport building, a factory building, a basement, but the term building may or may not also e.g. include a demarcated, delimited area, e.g. without or partly without a roof and/or walls, A building may in some examples also include trains, busses, cars, aeroplanes, etc. In further other examples, outdoor can be divided in outdoor and semi-outdoor wherein semi-outdoor could be outside, but shielded by a building, e.g. a user standing outside but close to a building wall.

It may also be referred to in other words that the UE 120 is indoors or not indoors, or as an alternative the UE 120 is outdoors or not outdoors. In some examples of the invention indoor and outdoor is further divided into subgroups, e.g.
Shielded indoor (e.g., building without windows, underground facility)
Semi-shielded indoor (building with windows)
Partly-shielded indoor (e.g., building with roof, but no walls)
Semi-outdoor (e.g., UE outdoor, but close to a building wall, or shielded by e.g. a building roof)
Open-space outdoor (a field without trees, or shielding buildings)
Non-open-space outdoor (in a forest)

An indicator may also be between fully indoor and fully outdoor, like an indoor probability value, where the indicator reflects the probability or likelihood that the UE (120) is indoors (or alternatively outdoors).

As mentioned above, embodiments herein are based on a capability of The UE 120 to establishing an indication whether the UE 120 is located indoors or outdoors which may be performed e.g. by classifying whether it is indoors or outdoors, or making a measurement of a quantity that is different indoors or outdoors.

It may be for example based on an ambient light analysis, but embodiments herein as such do not preclude other means to detect or assess whether the UE 120 is indoors or outdoors.

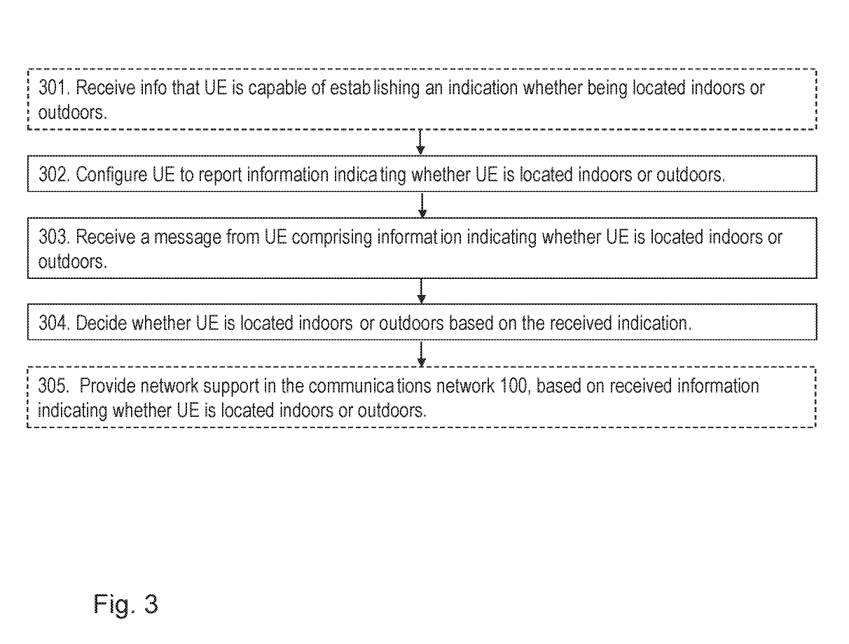

Example of embodiments of a method performed by the network node 110 will now be described with reference to FIG. 3. As mentioned above, the network node 110 and the UE 120 operate in the communications network 100.

The method may comprise the following actions, which actions may be taken in any suitable order. As mentioned above, in some embodiments the network node is represented by a distributed network node by means of cloud computing enabling ubiquitous network access to a shared pool of configurable computing resources. In these embodiments the actions below may be performed by different nodes.

Action 301

In some embodiments, the network node 110 receives a message from the UE 120, which message comprises information that the UE 120 is capable of establishing an indication whether it is located indoors or outdoors. This may be sent after requesting it by the network node 110 or be sent by the UE 120 without an explicit request. Thus the network node 110 may receive indoor/outdoor classification capability information from the UE 120.

Action 302

The network node 110 configures the UE 120 to report information indicating whether the UE 120 is located indoors or outdoors. This may be performed when the network node 110 wants to classify the UE 120 being indoor or outdoor by use of e.g. a positioning protocol such as LPP (LTE Positioning Protocol), see Section 5.3.1, 5.3.2. Alternatively, the network node 110 configures the UE 120 via RRC to report information indicating whether the UE 120 is located indoors or outdoors.

The network node 110 may provide assistance data to the UE 120 to be used for establishing the indication whether the UE 120 is located indoors or outdoors. The assistance data may be a specific signal or beacon signal such as a beacon signal transmitting a specific identity belonging to a set of identifiers that are associated to a specific indoor environment. Assistance data may also be data characteristics for indoor and outdoor that enable the UE 120 to make a more accurate decision whether the UE 120 is located indoor or outdoor.

The network node 110 may also provide report triggering information, to instruct the UE 120 when to report. Such triggering information may be on demand, which means that the UE 120 is requested to report directly, or within a time window, periodically which means that the UE 120 will report with a certain periodicity until for example a number of reports have been completed, or a criterion is met, or event-driven which means that the report is triggered when a criterion is met. Typical such criterions may e.g. comprise
when an associated measurement M is greater than a threshold T+H, possibly during a configurable time (time to trigger), where H is an optional hysteresis parameter,
when an associated measurement M is smaller than a threshold T-H, possibly during a configurable time (time to trigger), where H is an optional hysteresis parameter, and
when the indoor or outdoor classification has changed from one class to another.

Action 303

When the UE 120 has established an indicating whether the UE 120 is located indoors or outdoors e.g. by means of measurements associated to an indoor/outdoor classification, it sends e.g. by signalling, the indication to the network node 110.

A signalling possibility is provided by embodiments herein to enable reporting and/or signalling of the indication such as e.g. a measurement of the detection. This may for example be an indoor/outdoor bit informing the network node 110 that the UE 120 has classified itself as being indoor or outdoor. Furthermore, the reporting may possibly be extended to e.g. a 8 bit value resolving a UE-decided probability of being indoor or outdoor, or a more elaborated signalling/reporting where the UE 120 sends up a larger amount of information, making a decision basis for the communications network 100 to estimate if the UE 120 is indoors or outdoors. For example ambient light frequency distributions, temperature statistics, wind velocity statistics, etc. In general, the indication such as e.g. the measurements and assessments associated to indoor/outdoor classification may be referred to as Indoor-Outdoor Information, IOI.

The network node 110 thus receives a message from the UE 120. The message comprises the information indicating whether the UE 120 is located indoors or outdoors. The network node 110 e.g. receives information associated the indoor/outdoor classification from the UE 120.

Action 304

The network node 110 decides whether the UE 120 is located indoors or outdoors based on the received indication. The deciding, also referred to as the indoor/outdoor decision, enables the network node 110 to provide network support in the communications network 100 based on whether the UE 120 is located indoors or outdoors. The received indication may be information, such as e.g. the classification that the UE 120 is indoors or outdoors, or a measurement based on which the network node 110 can decide whether the UE 120 is indoors or outdoors. If it is an information, such as e.g. the classification that the UE 120 is outdoors, the network node 110 may decide according to the received indication that it is outdoors, but it may also decide opposite to the indication that the UE 120 is indoors, if it has additional knowledge pointing to the opposite of the indication, and vice versa. This may for example occur if the UE 120 wrongly reports that it is outdoor due to that e.g. the ambient light indoor has outdoor characteristics. Then the UE 120 reports that it is outdoors, but the network node 110 has also received radio measurement reports from the UE 120 that definitely indicates that the UE 120 is indoors.

Action 305

The network node 110 may provide network support in the communications network 100, based on the received information indicating whether the UE 120 is located indoors or outdoors.

In some embodiments, the network support comprises any one or more out of: adapting radio network algorithms related to the communications network 100, tuning the communications network 100, and providing to the communications network 100, positioning of the UE 120 based on whether the UE 120 is located indoors or outdoors. In some embodiments the network node 110 provides information about the positioning of the UE 120 to other UEs in the communications network 100 and vice versa information about other UEs positions is provided by the network node 110 to the UE 120, e.g. if it is in a narrow room indoors in a room in a building. The network support may also be an emergency support that is rarely triggered. For example, in case of a fire in a building the network such as the network node 110 may provide information to the fire rescue that persons, i.e. users of UEs being reported as indoor may still be in the building.

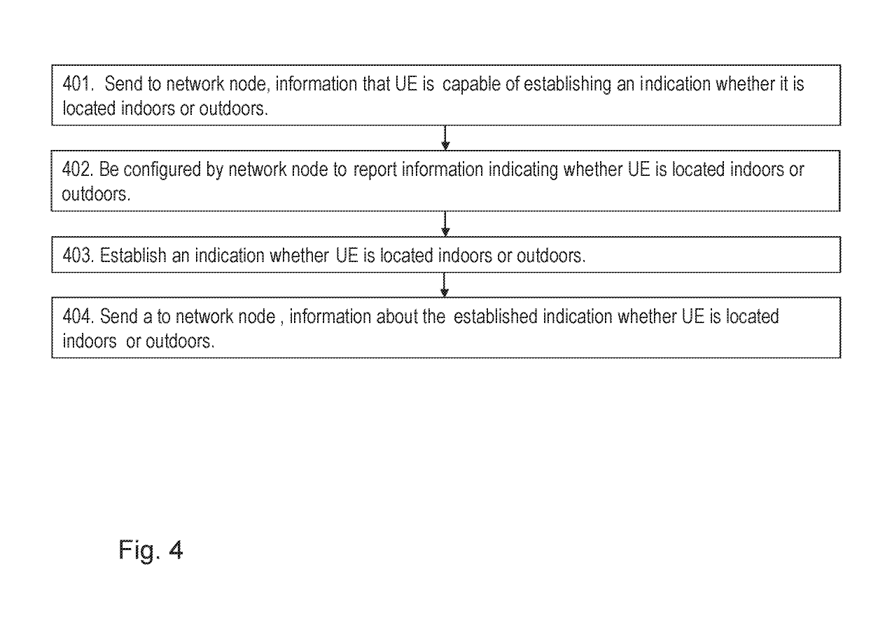

Example of embodiments of a method performed by the UE 120 will now be described with reference to FIG. 4. As mentioned above, the UE 120 and a network node 110 operate in the communications network 100.

The method may comprise the following actions, which action nay be taken in any suitable order.

Action 401

In some embodiments, the UE 120 sends a message to the network node 110, which message comprises information that the UE 120 is capable of establishing an indication whether it is located indoors or outdoors. This may be sent upon request by the network node 110.

Action 402

The UE 120 is configured by the network node 110 to report information indicating whether the UE 120 is located indoors or outdoors. See related Action 302 above. The network node 110 may further provide assistance data to the UE 120; to support the establishing of an indication whether the UE 120 is located indoors or outdoors indoor.

Action 403

The UE 120 establishes an indication whether the UE 120 is located indoors or outdoors. E.g. the UE makes measurements associated to an indoor/outdoor classification.

There may be different mechanisms in the UE 120 that can support indoor outdoor establishing. Some examples comprise:
Ambient light analysis, for example to determine the spectral characteristics of the light and compare to typical indoor light sources such as light bulbs, LEDs, fluorescent light, halogen lights. This may by itself be used to classify the type of light as plausibly generated by an indoor or outdoor source, but may also be regarded as a related measurement than may be fed back to the network node 110.
Indoor presence may be attributed to the detection of a specific signal or beacon signal that can be received by the UE 120, such as a beacon signal transmitting a specific identity belonging to a set of identifiers that are associated to a specific indoor environment.
Indoor presence might moreover be attributed to certain mobility patterns derived from the UE 120 on-board accelerometers.

It may be for example based on an ambient light analysis, but embodiments herein as such do not preclude other means to detect or assess whether the UE 120 is indoors or outdoors. This may e.g. be performed by means of a method described in Pengfei Zhou, Yuanqing Zheng, Zhenjiang Li, Mo Li, and Guobin Shen, “IODetector: A Generic Service for Indoor Outdoor Detection”, SenSys'12, Nov. 6-9, 2012, Toronto, ON, Canada, as mentioned above.

In some embodiments the UE 120 may establish different classes within the respective class indoor and class outdoor. In some examples of the indoor and outdoor is further divided into subgroups, e.g.
Shielded indoor (e.g., building without windows, underground facility)
Semi-shielded indoor (building with windows)
Partly-shielded indoor (e.g., building with roof, but no walls)
Semi-outdoor (e.g., UE outdoor, but close to a building wall, or shielded by e.g. a building roof)
Open-space outdoor (a field without trees, or shielding buildings)
Non-open-space outdoor (in a forest)

Action 404

The UE 120 then sends a message to the network node 110 which message comprises information about the established indication whether the UE 120 is located indoors outdoors. See more about this in the related Action 303 above.

The reported indication such as e.g. the indoor/outdoor classification information can be used by the network node 110 to enhance positioning by reducing the uncertainty to only indoor areas. For example, due to positioning inaccuracy there may be several possible true positions in some cases. By an additional indoor/outdoor classification some (hopefully all except one) of the possible positions may be ruled out since they are known to be outdoor.

Action 404

The UE 120 may then receive network support in the communications network 100, based on the reported indication whether the UE 120 is located indoors or outdoors.

As mentioned above, for example in case of a fire in a building the network such as the network node 110 may provide information to the fire rescue that persons, i.e. users of UEs being reported as indoor may still be in the building.

Also, in case of emergency call positioning it is desirable to map the positioning to an address to be sent to a public safety dispatcher coordinating Enhanced 911 (E911) efforts. Such an address is commonly referred to as a dispatchable address. E911 is a system that links emergency callers with the appropriate public resources. This mapping to the dispatchable address may be refined by using indoor/outdoor information.

This will be further described below.

The embodiments above will now be described more in detail and exemplified. This text below is applicable to any suitable embodiment described above.

This below relates to network support, e.g. as mentioned in Action 305 and 404 above.

In case the network node 110 is a base station, the base station may consider the indoor/outdoor decision such as e.g. the indoor/outdoor classification in the radio resource management to improve the user experience of the user of the UE 120 and/or other users of UEs. For example, indoor users such as the user of the UE 120 and/or users of other UEs may be assumed to be subject to specific mobility behavior, or may be requested by the network node 110 to start monitoring indoor cells on a dedicated frequency carrier.

The indoor/outdoor decision such as e.g. the indoor/outdoor classification may also be used to separate performance monitoring data into indoor and outdoor classes, making the data more informative to the operator and also provides better input to network tuning, network extension discussions and feature assessments.

Signaling Embodiments

As mentioned above, the UE 120 may be requested to provide information about its capabilities to establish whether it is indoors or outdoors, e.g. via LPP, LPPe, RRC, etc.

For example, in LPP a message content may be modified to accommodate an indoor/outdoor classification capability IndoorClassificationInfo, see underlined below, according to:

-- ASN1START
OTDOA-ProvideAssistanceData ::= SEQUENCE {

| | | | |
|---|---|---|---|
| otdoa-ReferenceCellInfo | OTDOA-ReferenceCellInfo | OPTIONAL, | -- Need ON |
| indoorClassificationInfo | IndoorClassificationInfo | OPTIONAL, | -- Need ON |
| otdoa-NeighbourCellInfo | OTDOA-NeighbourCellInfoList | OPTIONAL, | -- Need ON |
| otdoa-Error | OTDOA-Error | OPTIONAL, | -- Need ON |
| ... | | | |
| } | | | |

IndoorClassificationInfo ...
-- ASN1STOP

Wherein:

ASN1 means Abstract Syntax Notation One. It is standard and notation that describes rules and structures for representing, encoding, transmitting, and decoding data in telecommunications and computer networking.

OTDOA-ReferenceCellInfo means Observed Time Difference Of Arrival—Reference Cell Information

OTDOA-NeighbourCellInfoList means OTDOA—Neighbour Cell Information List.

OTDOA-Error provides OTDOA error reason.

Similarly, the UE 120 may receive assistance data to support indoor classification from the network node 110 such as an eNB via RRC, or such as from an E-SLMC via LPPe.

There are also different means to convey the established indication such as the IOI to the network node 110 in different embodiments:
When using LPP via LocationInformation messages
When using RRC via LocationInfo information element, or MDT IEs, or measurement reports
When using LPPe modified, like in the example below.

Embodiments herein may have an information field for Indoor Outdoor reporting or classification, for example similar the below example for atmospheric pressure in OMA-LPPe Extensions Specification.

OMA-LPPe-AtmosphericPressure

The OMA-LPPe-AtmosphericPressure represents the atmospheric pressure measured by the target.

-- ASN1START
OMA-LPPe-AtmosphericPressure := SEQUENCE {
pressureMeasurement OMA-LPPe-PressureMeasurement,
pressureStats PressureStats OPTIONAL,
calibrationPoints CalibrationPoints OPTIONAL,
...}
PressureStats ::= SEQUENCE {
sensorMeanPressure INTEGER (30000..115000),
sensorStddevPressure INTEGER (0..2000) OPTIONAL,
duration INTEGER (5..40),
...}
CalibrationPoints ::= SEQUENCE (SIZE (1..10)) OF SEQUENCE {
pressure OMA-LPPe-PressureMeasurement,
time UTCTime,
location EllipsoidPointWithAltitudeAndUncertaintyEllipsoid,
motionState OMA-LPPe-Sensor-MotionStateList OPTIONAL,
velocity Velocity OPTIONAL,
locationSource OMA-LPPe-LocationSource OPTIONAL,
...
}
-- ASN1STOP

Wherein:

UTCTime means Coordinated Universal Time.

EllipsoidPointWithAltitudeAndUncertaintyEllipsoid is description of a geographic shape as defined in 3GPP TS 23.032.

The OMA-LPPe-AtmosphericPressure is part of the LPP Extension specification and is given as an example LPPe information element. The information element OMA-LPPe-AmbientLight below, is given as an example of indoor outdoor indication information for an embodiment using LPPe for transmission of indoor outdoor indication information. However, this is just one example embodiment, where other embodiments may use LPP or RRC.

One such example using an ambient light metric as indoor outdoor indication information may look as the below information element:

The OMA-LPPe-Ambient Light represents the light spectral metric measured by the target, i.e. the UE 120.

-- ASN1START
OMA-LPPe-AmbientLight ::= SEQUENCE {
spectralMeasurement OMA-LPPe-SpectralMeasurement,
spectralStats SpectralStats OPTIONAL,
spectralMetric SpectralMetric OPTIONAL,
calibrationPoints CalibrationPoints OPTIONAL,
...}
SpectralStats ::= SEQUENCE {
sensorMeanWaveLength_nm INTEGER (100..3000),
sensorStddevWaveLength_nm INTEGER (0..200) OPTIONAL,
duration INTEGER (x..y),
...}
SpectralMetric ::= SEQUENCE { (SIZE (1..((3000−100)/50)) ) OF
SEQUENCE {
ambientlight OMA-LPPe-AmbientLight
...}
CalibrationPoints ::= SEQUENCE (SIZE (1..10)) OF SEQUENCE {
lightwavelength OMA-LPPe-SpectralMeasurement,
time UTCTime,
location EllipsoidPointWithAltitudeAndUncertaintyEllipsoid,
motionState OMA-LPPe-Sensor-MotionStateList OPTIONAL,
velocity Velocity OPTIONAL,
locationSource OMA-LPPe-LocationSource OPTIONAL,
...
}
-- ASN1STOP

Wherein

location EllipsoidPointWithAltitudeAndUncertaintyEllipsoid is description of a geographic shape as defined in 3GPP TS 23.032.

Further examples of establishing indoor outdoor indication information may be based on air humidity, temperature, wind speed, background noise, distance to surrounding objects, etc.

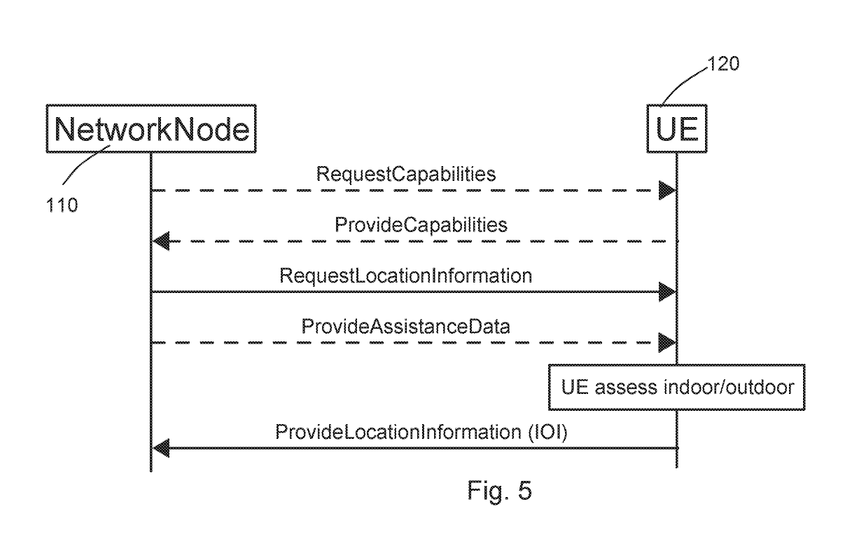

FIG. 5 schematically discloses example of signalling to support embodiments herein.

The information field would contain an indoor outdoor tag, in the simplest form one bit telling if UE 120 thinks it is indoors or outdoors. The information may also have the possibility to report indoor/outdoor with a probability low high. Furthermore, one option is to have a field where UE 120 may transmit Statistics to enable the network node 110 to make the decision on if the UE 120 is indoors or outdoors, in this case the indication comprises the statistics.

The indoor outdoor indication information may be requested on demand, or reported in an event-driven fashion such as only reported when it is subject to changes, like transiting from outdoor to indoor and vice versa. The indoor outdoor indication information may in some examples be reported periodically. In such examples the indoor outdoor indication information preferably comprises statistics of amount of indoor location and the amount of outdoor location during a measurement period, e.g. during the time since last report.

Utilization of IOI in the Network Node 110 e.g. for Network Support

The IOI may be utilized in the network node 110 in several ways, for example in some embodiments:
In the network node 110, for example, as being an E-SMLC, the IOI may be used to reduce the positioning uncertainty. For example, the positioning uncertainty of indoor users will be reduced to the indoor parts of the uncertainty, and vice versa for outdoor. The IOI may also be used to represent an indoor probability, to more accurately weight indoor and outdoor uncertainty part.
In the network node 110, for example based on UE-eNB signaling, to select one or more carriers to monitor based on IOI. For example, indoor systems e.g. within the communications network 110 may be configured with a specific set of carriers, and a UE such as the UE 120 indicated as indoor may be requested to monitor this specific set of carriers. In another example, indoor and outdoor UEs such as the UE 120 are assumed to be subject to different mobility behavior and are therefore configured with different handover parameters, radio condition feedback rates, etc.
In the network node 110 processing performance monitoring data, the data may be processed and separated based on IOI. For example, the data may be separated into indoor and outdoor classes to better analyze network issues.
The IOI may be utilized in the network node 110 as soon as it is received, or later when needed.

Embodiments herein provides a method in a wireless network such as the communications network 100, to e.g. receive an estimate of if the UE 120 is indoors or outdoors, or measurements to enable network estimation of if the UE is indoors or outdoors.

The communications network 100 such as the network node 110 may use the information to separate data in indoor and outdoor classes, configure UEs differently based on indoor and outdoor classes, and reduce positioning uncertainty based on indoor and outdoor assessments, etc.

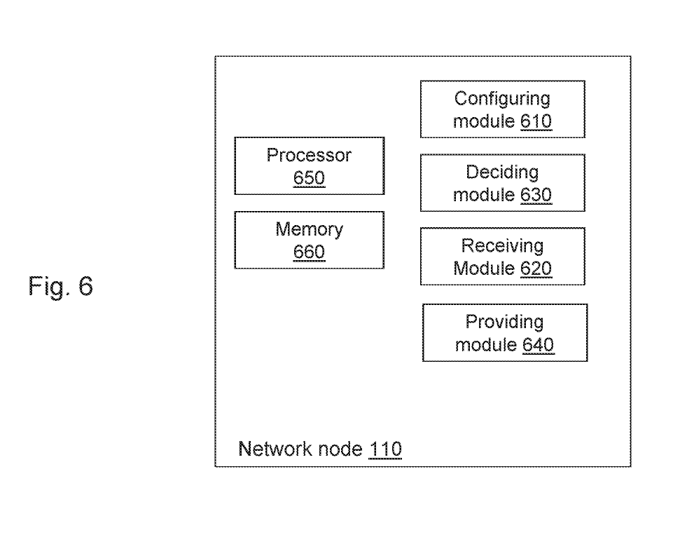

To perform the method actions described above in relation to FIG. 3, the network node 110 may comprise the following arrangement depicted in FIG. 6. As mentioned above, the network node 110 and a user equipment, UE, 120 are arranged to operate in a communications network 100.

The network node 110 is configured to, e.g. by means of an configuring module 610 configured to, configure the UE 120 to report information indicating whether the UE 120 is located indoors or outdoors.

The network node 110 is further configured to, e.g. by means of a receiving module 620 configured to, receive a message from the UE 120. Which message comprises the information indicating whether the UE 120 is located indoors or outdoors.

The network node 110 is further configured to, e.g. by means of a deciding module 630 configured to, decide whether the UE 120 is located indoors or outdoors based on the received indication. The deciding enables the network node 110 to provide network support in the communications network 100 based on whether the UE 120 is located indoors or outdoors.

The network node 110 is further configured to, e.g. by means of an providing module 640 configured to, provide network support in the communications network 100, based on the received information indicating whether the UE 120 is located indoors or outdoors.

In some embodiments, the network support comprises any one or more out of: adapting radio network algorithms related to the communications network 100, tuning the communications network 100, and providing to the communications network 100, positioning of the UE based on whether the UE 120 is located indoors or outdoors.

The network node 110 may further be configured to, e.g. by means of the receiving module 620 configured to, receive a message from the UE 120, which message comprises information that the UE 120 is capable of establishing an indication whether it is located indoors or outdoors.

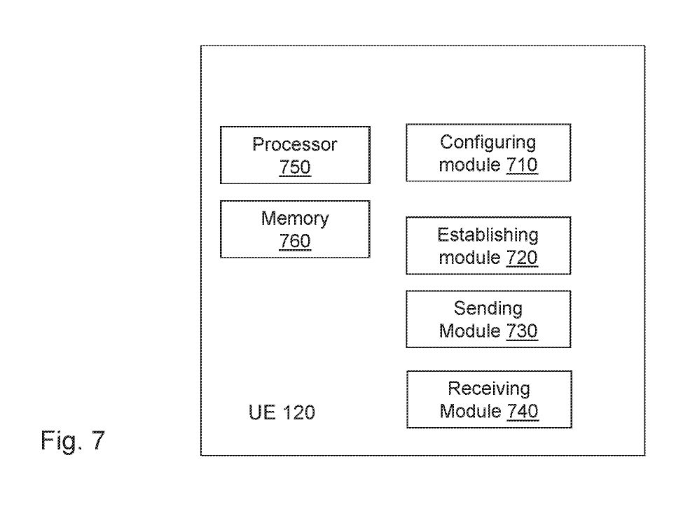

To perform the method actions described above in relation to FIG. 4, the UE 120 may comprise the following arrangement depicted in FIG. 7. As mentioned above, the UE 120 and the network node 110 are arranged to operate in the communications network 100.

The UE 120 is configured to, e.g. by means of a configuring module 710 configured to, be configured by the network node 110 to report information indicating whether the UE is located indoors or outdoors.

The UE 120 is further configured to, e.g. by means of an establishing module 720 configured to, establish an indication whether the UE 120 is located indoors or outdoors.

The UE 120 is further configured to, e.g. by means of a sending module 730 configured to, send a message to the network node 110 which message comprises information about the established indication whether the UE 120 is located indoors outdoors.

The UE 120 may further be configured to, e.g. by means of the sending module 730 configured to, send a message to the network node 110. The message comprises information that the UE 120 is capable of establishing an indication whether it is located indoors or outdoors.

The UE 120 may further configured to, e.g. by means of a receiving module 740 configured to, receive network support in the communications network 100, based on the reported indication whether the UE 120 is located indoors or outdoors.

The embodiments herein comprising the actions in the methods above may be implemented through one or more processors, such as a processor 650 in the network node 110 depicted in FIG. 6 and a processor 750 in the UE120 depicted in FIG. 7, together with computer program code for performing the functions and actions of the embodiments herein. The program code mentioned above may also be provided as a computer program product, for instance in the form of a data carrier carrying computer program code for performing the embodiments herein when being loaded into the network node 110 and/or the UE 120. One such carrier may be in the form of a CD ROM disc. It is however feasible with other data carriers such as a memory stick. The computer program code may furthermore be provided as pure program code on a server and downloaded to the network node 110 and/or the UE 120.

The network node 110 and/or the UE 120 may further comprise a memory comprising one or more memory units, such as the memory 660 comprised in the network node 110 depicted in FIG. 6 and the memory 760 comprised in the UE 120 depicted in FIG. 7. The respective memory 660 and memory 760 comprise instructions executable by the respective processor 650 and processor 750.

The respective memory 660 and memory 760 are arranged to be used to store e.g. data, configurations, IOI, UE capabilities and applications to perform the methods herein when being executed in the network node 110 and/or the UE 120.

Those skilled in the art will also appreciate that the modules in the network node 110 and/or the UE 120, described above may refer to a combination of analog and digital circuits, and/or one or more processors configured with software and/or firmware, e.g. stored in the respective memory 660 and memory 760, that when executed by the one or more processors such as the respective processor 650 and processor 750 as described above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

When using the word “comprise” or “comprising” it shall be interpreted as non-limiting, i.e. meaning “consist at least of”.

The embodiments herein are not limited to the above described preferred embodiments. Various alternatives, modifications and equivalents may be used. Therefore, the above embodiments should not be taken as limiting the scope of the invention, which is defined by the appending claims.

### ABBREVIATIONS

Abbreviation Explanation

3GPP 3rd Generation Partnership Project

BS Base Station, in LTE eNB

eNB/eNodeB Evolved Node B

E-SMLC Evolved-Serving Mobile Location Centre

GMLC Gateway Mobile Location Centre

GNSS Global Navigation Satellite System

IE Information Elements

IOI Indoor-Outdoor Information

LCS Location Services

LCS-AP LCS Application Protocol

LED Light-Emitting Diode

LPP LTE Positioning Protocol

LPPa LPP, part between eNodeB and E-SMLC

LPPe Extension protocol to LPP

MDT Minimize Drive Test

MME Mobility Management Entity

OMA Open Mobile Alliance

OTDOA Observed Time Difference of Arrival

RRC Radio Resource Control

TDOA Time Difference of Arrival

UE User Equipment

UTDOA Uplink TDOA

1-14. (canceled)

15. A method performed by a network node, which network node and a User Equipment (UE) operate in a communications network, the method comprising:
configuring the UE to report information indicating whether the UE is located indoors or outdoors;
receiving a message from the UE which message comprises the information indicating whether the UE is located indoors or outdoors; and
deciding whether the UE is located indoors or outdoors based on the received indication, which deciding enables the network node to provide network support in the communications network based on whether the UE is located indoors or outdoors.

16. The method of claim 15, further comprising:
providing network support in the communications network, based on the received information indicating whether the UE is located indoors or outdoors.

17. The method of claim 16, wherein the network support comprises any one or more out of: adapting radio network algorithms related to the communications network, tuning the communications network, and providing to the communications network, positioning of the UE based on whether the UE is located indoors or outdoors.

18. The method of claim 15, further comprising:
receiving a message from the UE, which message comprises information that the UE is capable of establishing an indication whether it is located indoors or outdoors.

19. A method performed by a User Equipment (UE), which UE and a network node operate in a communications network, the method comprising:
being configured by the network node to report information indicating whether the UE is located indoors or outdoors;
establishing an indication whether the UE is located indoors or outdoors; and
sending a message to the network node which message comprises information about the established indication whether the UE is located indoors outdoors.

20. The method of claim 19, further comprising:
sending a message to the network node, which message comprises information that the UE is capable of establishing an indication whether it is located indoors or outdoors.

21. The method of claim 19, further comprising:
receiving network support in the communications network, based on the reported indication whether the UE is located indoors or outdoors.

22. A network node configured to operate in a communications network that includes a User Equipment (UE), the network node being further configured to:
configure the UE to report information indicating whether the UE is located indoors or outdoors;
receive a message from the UE which message comprises the information indicating whether the UE is located indoors or outdoors; and
decide whether the UE is located indoors or outdoors based on the received indication, which deciding enables the network node to provide network support in the communications network based on whether the UE is located indoors or outdoors.

23. The network node of claim 22, wherein the network node further is configured to:
provide network support in the communications network, based on the received information indicating whether the UE is located indoors or outdoors.

24. The network node of claim 23, wherein the network support comprises any one or more out of: adapting radio network algorithms related to the communications network, tuning the communications network, and providing to the communications network, positioning of the UE based on whether the UE is located indoors or outdoors.

25. The network node of claim 22, wherein the network node further is configured to:
receive a message from the UE, which message comprises information that the UE is capable of establishing an indication whether it is located indoors or outdoors.

26. A User Equipment (UE) configured for operation in a communications network that includes a network node, the UE being further configured to:
be configured by the network node to report information indicating whether the UE is located indoors or outdoors;
establish an indication whether the UE is located indoors or outdoors; and
send a message to the network node which message comprises information about the established indication whether the UE is located indoors outdoors.

27. The UE of claim 26, wherein the UE further is configured to:
send a message to the network node, which message comprises information that the UE is capable of establishing an indication whether it is located indoors or outdoors.

28. The UE of claim 26, wherein the UE further is configured to:
receive network support in the communications network, based on the reported indication whether the UE is located indoors or outdoors.
